(19) United States
(12) Patent Application Publication
(10) Pub. No.: US 2026/0153875 A1
(43) Pub. Date: Jun. 4, 2026

(54) Method and Apparatus for Training a Machine Learning Model

(71) Applicant: Robert Bosch GmbH, Stuttgart (DE)

(72) Inventors: Max Keller, Berlin (DE); Ismail Ehab Ezzat Mehrez, Stuttgart (DE); Maxim Dolgov, Renningen (DE); Yakov Miron, Tuebingen (DE)

(21) Appl. No.: 19/403,810

(22) Filed: Nov. 29, 2025

(30) Foreign Application Priority Data
Dec. 3, 2024 (DE) 10 2024 211 523.1

(51) Int. Cl. G05D 1/633; G05B 13/02; G05D 101/15

(52) U.S. Cl. CPC G05D 1/633; G05B 13/0265; G05D 2101/15

(57) ABSTRACT

A method for training a machine learning model for an autonomous driving function, in particular for behavior prediction and/or behavior planning and/or for tracking one or more vehicles is disclosed. The method includes (i) deploying a training data set with training data elements, each of which includes scenario data as training input data and associated ground truth data, (ii) determining latent feature vectors for the scenario data using a feature embedding unit, (iii) clustering the training data elements into scenario clusters based on the latent feature vectors using a clustering algorithm, and (iv) determining scenario cluster weights by applying the scenario data of the training data elements to the machine learning model to be trained and comparing the output data of the machine learning model generated in this way with the ground truth data of the respective training data elements; determining a performance measure and/or a loss function based on the comparisons between the output data and the ground truth data; and determining or adjusting the scenario cluster weights based on the performance measure and/or loss function, (v) training the machine learning model with the training data set sampled taking into account the scenario cluster weights, and (vi) deploying the trained machine learning model.

This application claims priority under 35 U.S.C. § 119 to patent application no. DE 10 2024 211 523.1, filed on Dec. 3, 2024 in Germany, the disclosure of which is incorporated herein by reference in its entirety.

The disclosure relates to a method for training a machine learning model for an autonomous driving function, in particular for behavior prediction and/or behavior planning and/or for tracking one or more vehicles.

Furthermore, the disclosure relates to an apparatus for training a machine learning model for an autonomous driving function, in particular for behavior prediction and/or behavior planning and/or for tracking one or more vehicles.

### BACKGROUND

Adaptive or weighted sampling is an advanced technique in neural network training that plays a crucial role in improving learning efficiency and model performance, especially when large and diverse data sets need to be processed. In this approach, more informative or more challenging samples are selectively emphasized during training by dynamically adjusting the probability of their selection to the current learning state of the model. This is particularly important as it addresses several key challenges in machine learning.

One key aspect is the handling of unbalanced data sets. In many real-world use cases, data is unevenly distributed across different classes, so some classes have abundant examples while others are underrepresented. Adaptive sampling makes it possible to increase the probability of selecting rare or underrepresented classes, which helps to avoid bias towards more common classes and promotes a more balanced overall understanding.

Another advantage is the efficiency of learning. Conventional training methods that use uniform sampling often invest excessive resources in easy-to-learn examples that contribute little to model improvement after a certain phase. Adaptive sampling, on the other hand, focuses on more difficult examples that challenge the model or are close to the decision boundary. This makes the training process more efficient, as the model can learn more quickly from its mistakes and apply this knowledge to similar, difficult cases.

In the context of automated driving functions, such as predicting the behavior of other road users and planning an automated vehicle's or fleet's own route (cooperative planning), trajectory and scenario data are obtained from sensor data. It may be necessary to give greater weighting to certain scenarios, such as intersections, passing maneuvers or parking maneuvers, during training in order to improve model performance in these critical situations.

Some machine learning models for automated driving that work using scenario data, such as prediction, planning and tracking models, handle certain scenario classes better than other models. However, such machine learning models tend to handle certain scenario classes better than others and often tend to over-adapt to simple scenarios, such as driving straight ahead. Adaptive sampling should therefore take place at the level of the scenario classes. However, this requires a prior classification of the scenarios, which is a complex challenge due to the large variety and combinations of scenarios in automated driving.

An excessive number of scenario classes also means that adaptive sampling requires a large number of samples in order to determine a suitable weight for each class. This represents a challenging combination of classification and sampling problems that need to be solved in order to train neural networks for automated driving in a balanced and efficient way.

It is therefore a task addressed by the disclosure to provide an improved method and/or improved apparatus.

The problem is solved by a method according to the features set forth below. The problem is solved by an apparatus according to the features also set forth below.

### SUMMARY

According to a first aspect, a method is proposed for training a machine learning model for an autonomous driving function, in particular for behavior prediction and/or behavior planning and/or for tracking one or more vehicles, the method comprising the steps of: deploying a training data set with training data elements, each of which comprises scenario data as training input data and associated ground truth data; determining latent feature vectors for the scenario data using a feature embedding unit; clustering the training data elements into scenario clusters based on the latent feature vectors using a clustering algorithm; determining scenario cluster weights by applying the scenario data of the training data elements to the machine learning model to be trained and comparing the output data of the machine learning model generated in this way with the ground truth data of the respective training data elements; determining a performance measure and/or a loss function based on the comparisons between the output data and the ground truth data; and determining or adjusting the scenario cluster weights based on the performance measure and/or loss function; training the machine learning model with the training data set sampled taking into account the scenario cluster weights; and deploying the trained machine learning model.

Each element in the data set represents a single scenario, e.g., a specific traffic event such as an intersection situation, a passing maneuver, or a parking maneuver. These elements form the smallest units with which the model is trained. The scenario data represents input data that the machine learning model receives during training. They comprise information such as sensor data (camera, radar or lidar data) or other traffic information (e.g. positions, speeds, relations to other objects). Scenario data reflects the real environment in which the autonomous vehicle moves and serves as input to control the behavior of the model. The ground truth data are the correct target values or reference data that the model should generate as output. For each training data element, there is a corresponding ground truth that describes, for example, the correct behaviors, positions, or decisions in each situation. Ground truth data is often annotated manually or using algorithms to provide a reliable assessment of model performance. The scenario data (input) and the ground truth data (target values) together form the basis for training the model. The model is optimized by learning to process the inputs in such a way that it reproduces the target values as accurately as possible.

The feature of clustering the training data elements based on the latent feature vectors in scenario clusters using a clustering algorithm describes a classification as a special form of clustering.

Clustering is an unsupervised learning process in which data points are divided into groups or clusters based on their similarity or other criteria.

These groups are created from the data itself, without predefined labels or classes. The aim is to group data points in such a way that they are as similar as possible within a cluster and as different as possible between clusters.

Classification, on the other hand, is a supervised learning process in which specific labels or classes are assigned to data points. These labels are defined in advance, and the model is trained to assign new data points to one of these classes. Classification therefore requires prior knowledge of the structure of the classes.

Classification as a special form of clustering therefore means that the classes are essentially treated like clusters, with the difference that they are already defined. In contrast to classic clustering, in which the groups are created dynamically during the process, classification is an assignment to fixed, known groups.

In the context of the feature according to the disclosure, this means that classification is a more structured and targeted variant of clustering. The groups to which data points are to be assigned already exist and are described by labels, e. g., “intersection,” “passing maneuver,” or “parking maneuver.” When classifying, the “cluster centers” could be represented by the predefined classes, whereby the assignment is clearly specified.

Clustering in step S3 is therefore a targeted application of clustering in which scenario data is categorized into specific, predefined classes. This is particularly useful in training, as it allows the machine learning model to be optimized specifically for weaknesses in individual classes.

The training data set comprises a set of samples, wherein each sample contains a sequence of time steps and the corresponding ground truth. This ground truth data is used later in the method to evaluate the performance of the machine learning model. The samples can be available either as individual images or as sequence data.

The method further comprises iteratively repeating steps (S3) to (S5) over multiple training epochs, wherein the scenario cluster weights are updated after each epoch based on current model performance.

This is done by applying the samples to the current model and evaluating the model performance using the loss function or the performance measure. This iterative process ensures that the training dynamically addresses the current weaknesses of the model by focusing more strongly on scenario clusters that have not yet performed optimally.

The performance measure or loss function preferably refers to the machine learning model and its current performance. It is therefore preferable to determine the latent characteristic vector of (each) scenario in the data set. Furthermore, the clustering algorithm is preferably applied. A predetermined number of clusters can be defined. Alternatively, depending on the algorithm used, an indefinite number of clusters can also be found. The scenario cluster weights are preferably determined based on an initial training epoch for each subsequent training epoch. In this way, the machine learning model can be trained in each training epoch with an updated partial data set sampled from the entire data set based on the current scenario cluster weights.

It is understood that the steps according to the disclosure and further optional steps do not necessarily have to be carried out in the order shown but may also be carried out in a different order. Furthermore, intermediate steps may also be provided. The individual steps may also comprise one or more sub-steps without going beyond the scope of the method according to the disclosure.

According to a second aspect, an apparatus for training a machine learning model for behavior prediction and/or behavior planning and/or for tracking one or more vehicles having an autonomous driving function, wherein the apparatus comprises: a deployment unit for deploying a training data set with training data elements, each of which comprises scenario data as training input data and associated ground truth data; a determination unit for determining latent feature vectors for the scenario data by way of a feature embedding unit; a cluster unit for clustering the training data elements based on the latent feature vectors into scenario clusters by way of a clustering algorithm; a determination unit for determining scenario cluster weights by applying the scenario data of the training data elements to the machine learning model to be trained and comparing the output data of the machine learning model generated in this way with the ground truth data of the respective training data elements, determining a performance measure and/or a loss function based on the comparisons between the output data and the ground truth data and determining or adjusting the scenario cluster weights based on the performance measure and/or the loss function; a training session for training the machine learning model with the training data set sampled taking into account the scenario cluster weights; and a provision unit for deploying the trained machine learning model.

The determination unit is a component that embeds the scenario samples in the latent feature space. The cluster unit comprises a clustering algorithm that works in the latent feature space. For example, the determination unit is a component that determines the sampling weights of the scenario clusters based on a performance measure or a loss function used in training for each sample drawn. A reference catalog of samples can also be available, based on which the sampling weights can be determined. Furthermore, implementation in the training pipeline of the machine learning model is carried out by a weighted sampler that takes into account the sampling weights of the scenario clusters.

The explanations given for the method apply to the apparatus accordingly. In this regard, any linguistic modifications of features formulated in terms of the method can be reformulated for the apparatus in accordance with standard linguistic practice, without such formulations having to be explicitly listed here.

This paper proposes a solution to the problem described above by first clustering scenario data in latent space and using the resulting not-too-large number of clusters for adaptive and weighted sampling.

Especially in the field of automated driving, adaptive sampling at scenario cluster level instead of sample level can be advantageous. This makes it possible to determine which scenario clusters the machine learning model, for example a neural network, can handle well and which scenario clusters are not handled well by the model. This also has the advantage that not every sample has to be drawn in the previous training epochs in order to determine its probability (weight) for future sampling appropriately. Rather, it is sufficient to draw a representative sample from each scenario cluster and thus determine a probability for the entire scenario cluster.

The method thus offers a clear simplification of scenario clustering and thus the training of machine learning models on different scenario clusters. Such machine learning models can preferably be used for behavior prediction and/or behavior planning for automated driving.

The method uses clustering algorithms such as k-Means in the latent feature space to determine scenario clusters, especially in the field of automated driving, with adaptive and weighted sampling of scenario clusters during the training of the machine learning model. The disclosure focuses on the training method of the machine learning model. In inference, an improved machine learning model can thus be provided.

The advantage of this is the simplification of the scenario clustering problem, as scenario clusters no longer have to be defined manually. In this way, the undetectable number of scenario clusters in the field of automated driving can be broken down to a small number of clusters. This simplifies, for example, the training of a machine learning model for behavior prediction and/or behavior planning for automated driving.

This is achieved by using a smaller number of scenario clusters, which allows fewer samples to be drawn and also allows meaningful weights to be determined for adaptive and weighted sampling during a training epoch. This leads to a balanced trained machine learning model for behavior prediction and/or behavior planning for automated driving. The machine learning model offers improved performance in relation to various scenario clusters, as adaptive sampling during training ensures that scenario clusters in which performance is insufficient are weighted more heavily.

In a further aspect, it is proposed that the calculation of a scenario performance and the associated scenario weights for the next training epoch be based on scenarios from a validation data set that lie in the same scenario cluster, rather than on the scenario samples sampled for training and the result of the loss function or performance measure. This makes it possible to align the training of the machine learning model with the validation data set, which is generally the goal in machine learning.

It should also be mentioned that in other aspects of the disclosure, the sampling method presented and the scenario clusters can also be used for black-box optimization (Bayesian optimization), since in particular no gradients are required. This means that the disclosure can also be used for general optimization outside of deep learning.

In a further aspect, it is proposed that the machine learning model be trained iteratively, in several training steps, whereby the scenario cluster weights are recalculated after each training step and the training data set for the subsequent training step is sampled with the new scenario cluster weights.

Iterative adjustment of the cluster weights means that the performance of the machine learning model is evaluated after each training step in order to determine which scenario clusters the model already understands well and in which it still has weaknesses. The scenario cluster weights are adjusted based on this analysis: Clusters with poorer model performance are weighted higher in order to be considered more frequently in the next training step.

Instead of using the same training data set every time, a part of the data set is selected dynamically using weighted sampling. This ensures that scenarios that the model has already mastered are sampled less frequently, while difficult or underrepresented scenarios are given greater prominence.

The multiple use of the training data set through differentiated sampling thus leads to an increase in efficiency through targeted selection, an optimization of model performance and an avoidance of overfitting to frequent scenarios. This leads to an increase in training quality without requiring additional data or resources. The approach ensures that the model is robust and performs well in a plurality of scenarios, which contributes to safe use in autonomous driving.

In a further aspect, it is proposed that the feature embedding unit comprises an autoencoder which is preferably adapted to sequence data of the training data set.

Other types of feature embedding are also conceivable, so that the encoder mentioned is only to be understood as an example and not restrictive.

In a further aspect, it is proposed that the clustering algorithm comprises a k-means algorithm and/or a nearest neighbor algorithm.

Other classification or clustering algorithms are also conceivable, so that the list here is not to be understood as restrictive.

In a further aspect, it is proposed that determining the scenario cluster weights using the performance measure or loss function comprises: forming a mean value across scenario clusters followed by normalization across the sum of all scenario clusters; and/or, in an initial training epoch, setting the scenario cluster weights as random or evenly distributed scenario cluster weights. The mean value is preferably determined for each individual scenario cluster and then normalized across all scenario clusters. Furthermore, the initial weight can be determined based on the size of the scenario clusters. This can reflect an initial scenario distribution, for example.

In another aspect, it is proposed that the cluster weights are calculated based on performance metrics of intermediate results or samples.

Instead of calculating the sampling weights based on the overall performance of the machine learning model, i.e. the output of the loss function or the performance metrics, it is also possible that the sampling weights are calculated based on performance metrics of intermediate results. This enables, for example, fine-tuning or sub-network training with the training method presented.

In a further aspect, it is proposed that the method has an adaptive refinement of the scenario clusters into sub-scenario clusters.

Adaptive refinement of scenario clusters into sub-scenario clusters during training is also conceivable. Here, for example, in the event of a (permanently) poor performance of the machine learning model on a scenario cluster, binary decisions could be made to divide the scenario cluster into further clusters.

In another aspect, it is proposed that the sub-scenario clusters are added to the scenario clusters, and a sampling probability is dynamically adjusted based thereon.

These sub-scenario clusters can be added to the previously introduced scenario clusters, and the sampling probability can be dynamically adjusted. This sub-embodiment solves the problem of the difficulty of defining a fixed number of scenario clusters in advance that, for example, fully describe the problem of automated driving and make it learnable for the machine learning model.

It is also conceivable that the validation and/or test data for validating or testing the machine learning model is selected adaptively by the sampling process.

In a further aspect, a control unit is also described which is comprised in a vehicle having an autonomous driving function and/or a robotic system and/or an industrial machine, and on which the present method is executable in one of its aspects.

In a further aspect, a computer program comprising program code is described for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIG. 1 shows a schematic flowchart of an exemplary embodiment of the present method.

FIG. 2 shows an abstract visual representation of scenario clustering in latent feature space.

FIG. 3 shows a schematic representation of the adaptive and weighted scenario cluster sampling process during training.

### DETAILED DESCRIPTION

In the figures of the drawings, identical reference numbers denote identical or functionally identical elements, parts or components, unless stated otherwise.

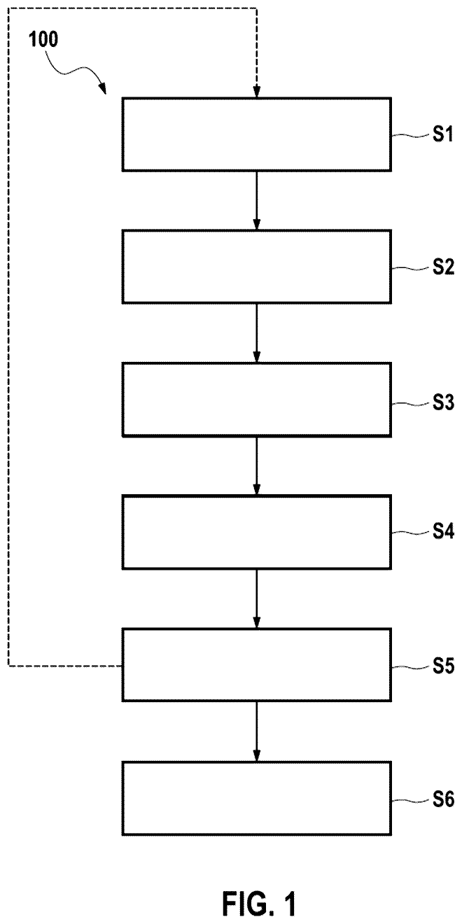

FIG. 1 shows a schematic flowchart of a method for training a machine learning model for an autonomous driving function, in particular for behavior prediction and/or behavior planning and/or for tracking one or more vehicles

The method can be carried out in any embodiment, at least in part, by an apparatus 100 which may comprise several components not shown in detail, for example one or more provision devices and/or at least one evaluation and calculation unit. It is understood that the provision device may be configured so as together with the evaluation-and-calculation unit or may be different from it. Furthermore, the apparatus 100, which may be part of a system, may comprise a storage device and/or an output device and/or a display device and/or an input device.

The method also includes at least the following steps:
In step S1, a training data set is deployed with training data elements, each of which comprises scenario data 204 as training input data and associated ground truth data.
In a step S3, latent feature vectors for the scenario data 204 are determined by way of a feature embedding unit
In a step S3, the training data elements are clustered into scenario clusters 202 on the basis of the latent feature vectors using a clustering algorithm
In step S4, scenario cluster weights are determined by applying the scenario data of the training data elements to the machine learning model to be trained and comparing the output data of the machine learning model generated in this way with the ground truth data of the respective training data elements, determining a performance measure and/or a loss function based on the comparisons between the output data and the ground truth data, and determining or adjusting the scenario cluster weights based on the performance measure and/or the loss function.
In step S5, the machine learning model is trained with the training data set sampled taking into account the scenario cluster weights.
In step S6, the trained machine learning model is deployed.

The dashed arrow from S5 to S3 and S5 to S4 preferably reflects an iteration over several epochs.

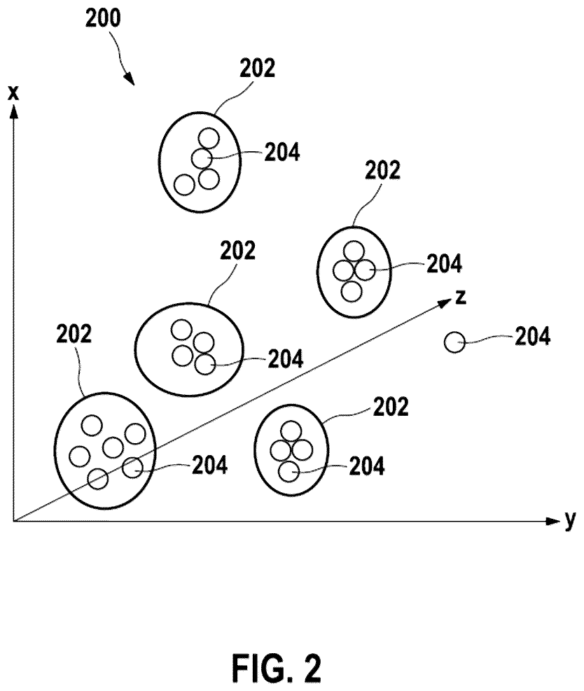

FIG. 2 shows an abstract visual representation of a scenario clustering in the latent feature space 200. FIG. 2 shows an abstract representation of the scenario clustering described here in the latent feature space 200. The latent feature space 200 can be of any dimension; the three axes x, y, z shown here are for visualization purposes only and do not limit the object of the disclosure. Several clusters 202 of scenario samples 204 are displayed in the feature space 200. The scenario samples 204 are the scenario data or scenario data samples mentioned above.

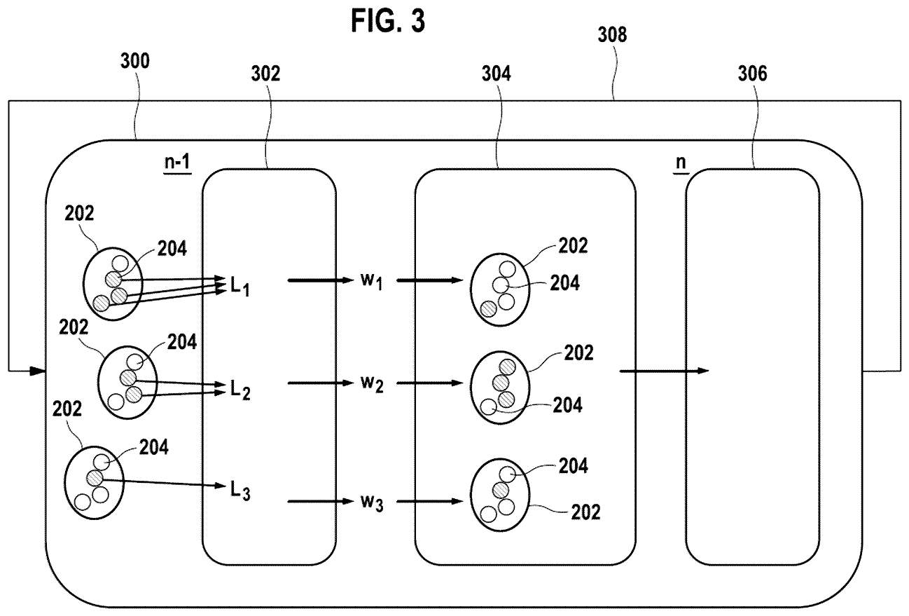

FIG. 3 shows a schematic representation of the adaptive and weighted scenario cluster sampling process during training. Two training epochs n-1 and n are shown in a training block 300. The clusters 202 are shown for the n-1th and nth training epochs. Cluster 202 contains scenarios that have already been sampled and scenarios that have not yet been sampled. After the n-1th epoch, the scenario cluster weights w1-w3 are calculated in a block 302 on the basis of the average scenario performance L1-L3. A sampling based on the newly calculated scenario cluster weights w1-w3 then takes place in block 304. In a block 306, a training of the machine learning model based on the scenarios 204 newly sampled in block 304. The process is then repeated for the next training epoch, which is indicated by a return 308.

What is claimed is:

1. A method for training a machine learning model for an autonomous driving function, comprising:
deploying a training data set with training data elements, each of which comprises scenario data as training input data and associated ground truth data;
determining latent feature vectors for the scenario data using a feature embedding unit;
clustering the training data elements into scenario clusters based on the latent feature vectors using a clustering algorithm;
determining scenario cluster weights by:
applying the scenario data of the training data elements to the machine learning model to be trained and comparing the output data of the machine learning model generated in this way with the ground truth data of the respective training data elements;
determining a performance measure and/or a loss function based on the comparisons between the output data and the ground truth data; and
determining or adjusting the scenario cluster weights based on the performance measure and/or loss function;
training the machine learning model with the training data set sampled taking into account the scenario cluster weights; and
deploying the trained machine learning model.

2. The method according to claim 1, wherein the machine learning model is trained iteratively in several training steps, and wherein the scenario cluster weights are recalculated after each training step and the training data set for the subsequent training step is sampled with the new scenario cluster weights.

3. The method according to claim 1, wherein the feature embedding unit comprises an autoencoder which is configured to sequence data of the training data set.

4. The method according to claim 1, wherein the clustering algorithm comprises a k-means algorithm and/or a nearest neighbor algorithm.

5. The method according to claim 1, wherein the determining scenario cluster weights comprises determining the scenario cluster weights using the performance measure or the loss function: forming an average value across scenario clusters, followed by normalization across the sum of all scenario clusters; and/or, in an initial training epoch, setting the scenario cluster weights as random or evenly distributed scenario cluster weights.

6. The method according to claim 1, wherein the scenario cluster weights are calculated based on performance metrics of intermediate results.

7. The method according to claim 1, further comprising adaptively refining the scenario clusters into sub-scenario clusters.

8. The method according to claim 7, wherein the sub-scenario clusters are added to the scenario clusters, and a sampling probability is dynamically adjusted based thereon.

9. A computer program comprising program code to execute at least portions of the method according to claim 1 if the computer program is executed on a computer.

10. A computer-readable data carrier with program code of a computer program for executing at least portions of the method according to claim 1 when the computer program is executed on a computer.

11. An apparatus for training a machine learning model for behavior prediction and/or behavior planning and/or for tracking one or more vehicles having an autonomous driving function, wherein the apparatus comprises:
a deployment unit configured to deploy a training data set with training data elements, each of which comprises scenario data as training input data and associated ground truth data;
a determination unit configured to determine latent feature vectors for the scenario data by way of a feature embedding unit;
a cluster unit configured to cluster the training data elements based on the latent feature vectors in scenario clusters by a clustering algorithm;
a determination unit configured to determine scenario cluster weights by:
applying the scenario data of the training data elements to the machine learning model to be trained and comparing the output data of the machine learning model generated in this way with the ground truth data of the respective training data elements;
determining a performance measure and/or a loss function based on the comparisons between the output data and the ground truth data; and
determining or adjusting the scenario cluster weights based on the performance measure and/or loss function;
a training session configured to train the machine learning model with the training data set sampled taking into account the scenario cluster weights; and
a deployment unit configured to deploy the trained machine learning model.

12. The method according to claim 1, wherein the autonomous driving function includes behavior prediction and/or behavior planning and/or tracking one or more vehicles.

13. The method according to claim 1, wherein the determining scenario cluster weights comprises determining the scenario cluster weights using the performance measure or the loss function: forming a mean value for each scenario cluster, followed by normalization across the sum of all scenario clusters; and/or, in an initial training epoch, setting the scenario cluster weights as random or evenly distributed scenario cluster weights.
